(19) United States
(12) Patent Application Publication
(10) Pub. No.: US 2026/0122105 A1
(43) Pub. Date: Apr. 30, 2026

(54) PROVIDING PROTECTION FOR RESOURCES OF A DEVICE

(71) Applicant: Juniper Networks, Inc., Sunnyvale, CA (US)

(72) Inventors: Erin C. MACNEIL, Carp (CA); Prashant SINGH, Santa Clara, CA (US)

(21) Appl. No.: 18/931,172

(22) Filed: Oct. 30, 2024

(51) Int. Cl. H04L 9/40; G06F 9/54; H04L 47/215; H04L 47/263

(52) U.S. Cl. CPC H04L 63/1458; G06F 9/547; H04L 47/215; H04L 47/263; H04L 63/0236

(57) ABSTRACT

A device may receive packets or an application programming interface (API) request associated with resources of the device. The device may apply, to the API request, an API hook that limits a request rate of a rate limiter of the device and protects the resources of the device. The device may perform one or more actions based on the API hook.

### BACKGROUND

A device, such as a network device, may include a rate limiter or a policer. A rate limiter may be implemented using several models, such as a token bucket model, a leaky bucket model, a sliding window model, and/or the like.

### SUMMARY

Some implementations described herein relate to a method. The method may include receiving packets or an application programming interface (API) request associated with resources of a device. The method may include applying, to the API request, an API hook that limits a request rate of a rate limiter of the device and protects the resources of the device, and performing one or more actions based on the API hook.

Some implementations described herein relate to a device. The device may include one or more memories and one or more processors. The one or more processors may be configured to receive packets or an API request associated with resources of the device, wherein the resources are kernel resources of the device. The one or more processors may be configured to apply, to the API request, an API hook that limits a request rate of a rate limiter of the device and protects the resources of the device, and perform one or more actions based on the API hook.

Some implementations described herein relate to a non-transitory computer-readable medium that stores a set of instructions. The set of instructions, when executed by one or more processors of a device, may cause the device to receive packets or an API request associated with resources of the device, wherein the resources are tables of the device. The set of instructions, when executed by one or more processors of the device, may cause the device to apply, to the API request, an API hook that limits a request rate of a rate limiter of the device and protects the resources of the device, and perform one or more actions based on the API hook.

### BRIEF DESCRIPTION OF THE DRAWINGS

FIGS. 1A-1G are diagrams of an example associated with providing protection for garbage collection supported resources of a device.

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for providing protection for garbage collection supported resources of a device.

### DETAILED DESCRIPTION

The following detailed description of example implementations refers to the accompanying drawings. The same reference numbers in different drawings may identify the same or similar elements.

A rate limiter of a device may utilize a token bucket model that generates tokens at a regular pre-defined interval (e.g., a static token refresh interval). The rate limiter may utilize the tokens on a first-come-first-served basis, such that a first flow (e.g., traffic) may utilize the tokens. If the first flow is associated with a distributed denial-of-service (DDoS) attack, all of the tokens of the rate limiter may be utilized for the DDoS flow, and legitimate flows (e.g., traffic) may be dropped by the device. The device may utilize an operating system (e.g., Linux) with resources (e.g., tables) that are consumed (e.g., a table becomes full). When such resources are consumed, resource request errors may occur in a kernel of the operating system or in an application. The resource request errors may cause a functionality failure for the application and/or may be catastrophic to the application (e.g., causing the application to abort). For example, an overflow may occur in a connection tracking table that tracks and maintains connection information, in a neighbor table that maintains address reservation protocol (ARP) entries, and/or the like.

While a rate limiter may be programmed for such traffic, a rate at which the traffic is throttled by the rate limiter fails to guarantee optimal use of the resource tables and avoidance of table overflows (e.g., since the rate limiter is now aware of maximum resource capacities and current resource states). Furthermore, the rate limiter is applied at a traffic entry point and not during resource usage. Thus, a packet for an existing entry in a resource table may consume a token and result in other packets getting dropped when all of the tokens are exhausted. An attacker may target resource overflows to aggressively trigger a forced garbage collection and disrupt existing resource table entries and respective services.

Thus, current techniques for utilizing a rate limiter consume computing resources (e.g., processing resources, memory resources, communication resources, and/or the like), networking resources, and/or the like, associated with failing to provide optimal use of resource tables, failing to prevent resource table overflows, dropping legitimate packets due to generating tokens for illegitimate packets, handling customer complaints associated with resource table overflows and dropping legitimate packets, and/or the like.

Some implementations described herein relate to a device that provides protection for garbage collection supported resources of the device. For example, the device may receive packets or an application programming interface (API) request associated with resources of the device. The device may apply, to the API request, an API hook that limits a request rate of a rate limiter of the device and protects the resources of the device, and may perform one or more actions based on the API hook. Alternatively, or additionally, the device may rate limit the packets based on referring to a local resource copy of the device, and may consume a token for one of the packets not associated with an entry in the local resource copy. Alternatively, or additionally, the device may determine a total quantity of available tokens of the rate limiter at a next interval associated with a garbage collector of the device, may calculate a token rate for the next interval based on the total quantity of available tokens, and may update the rate limiter with the token rate.

In this way, the device provides protection for garbage collection supported resources of the device. For example, the device may apply an extended Berkeley packet filter (eBPF) hook to an API request, where the eBPF hook rate limits a request rate of a rate limiter and protects the kernel resources. The eBPF hook may be applied to the API requests that are invoked only when a resource is created. Alternatively, or additionally, the device may rate limit packets by referring to a local resource copy associated with resources of the device. Alternatively, or additionally, for resources associated with a garbage collector, the device may utilize a garbage collector interval as a parameter for calculating a total quantity of currently available tokens and a token rate for the rate limiter. This may protect the resources of the device by preventing resource exhaustion and promoting fair resource distribution over time. Thus, the device conserves computing resources, networking resources, and/or the like that would otherwise have been consumed by failing to provide optimal use of resource tables, failing to prevent resource table overflows, dropping legitimate packets due to generating tokens for illegitimate packets, handling customer complaints associated with resource table overflows and dropping legitimate packets, and/or the like.

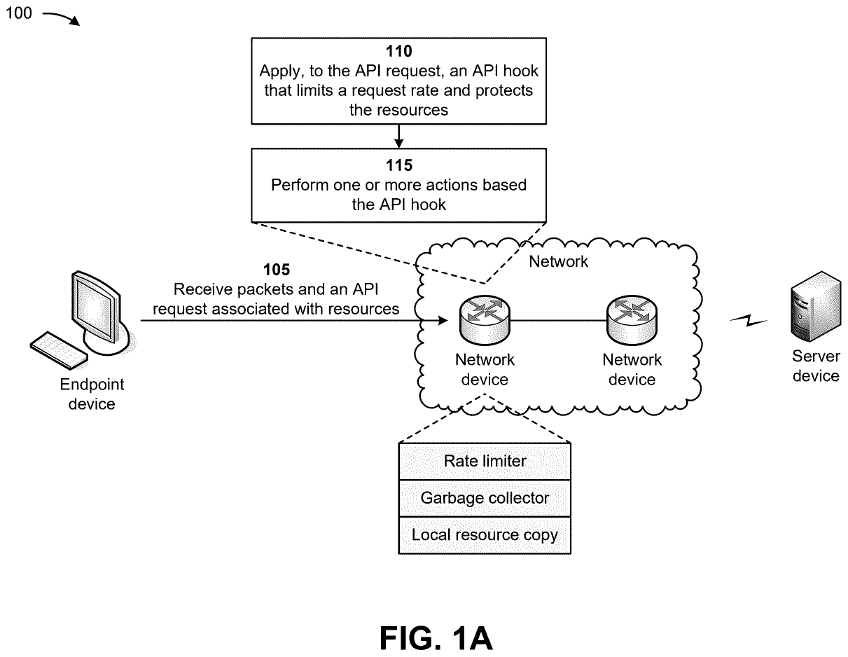

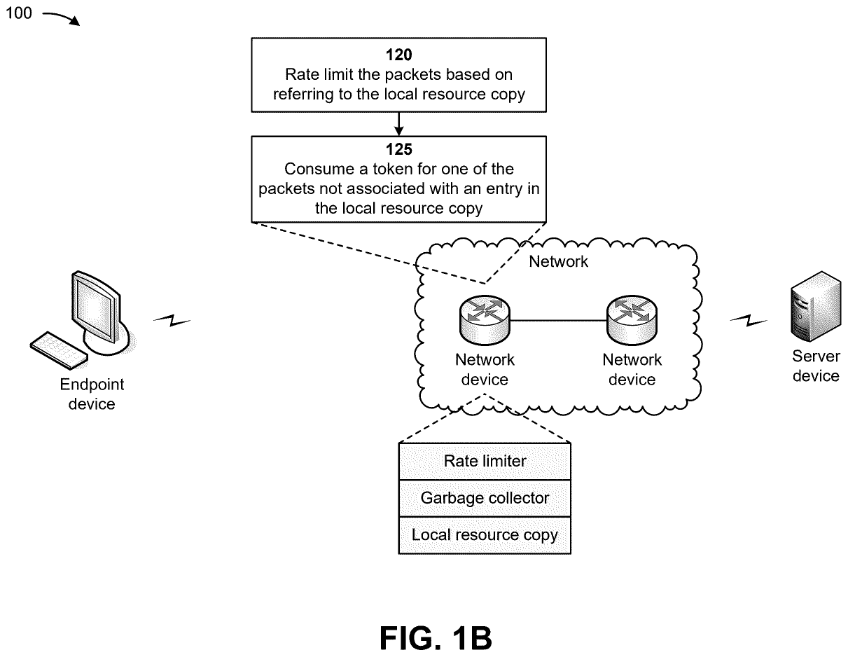

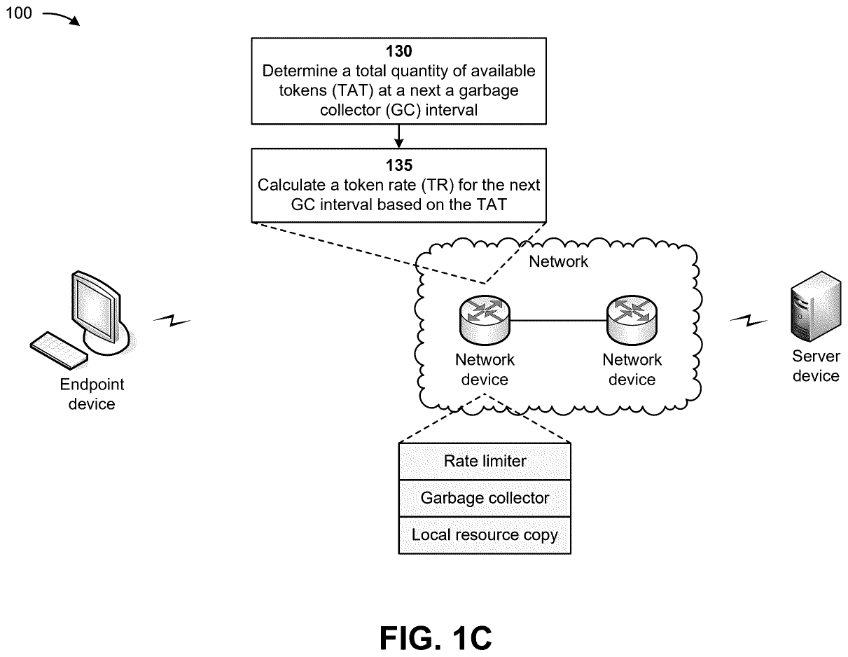

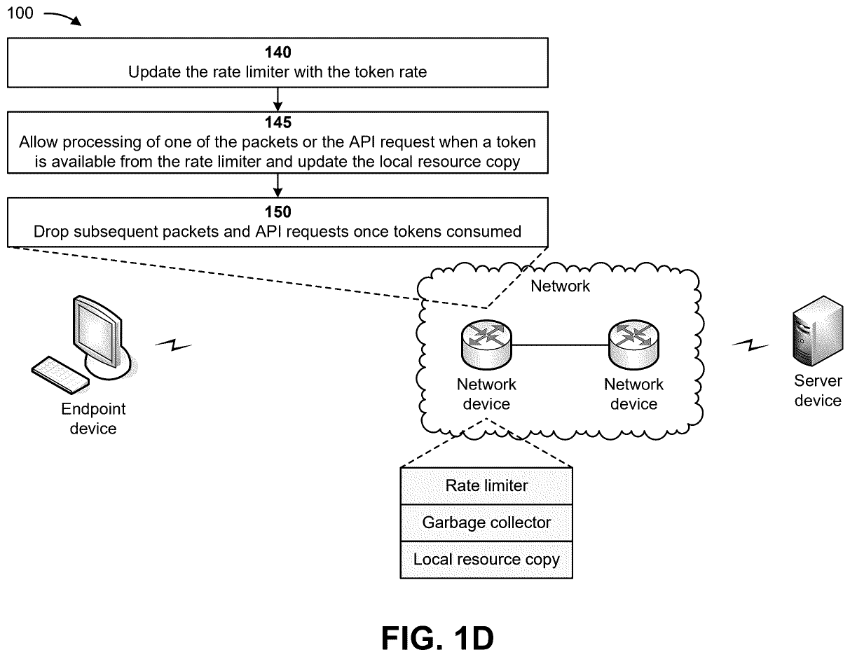

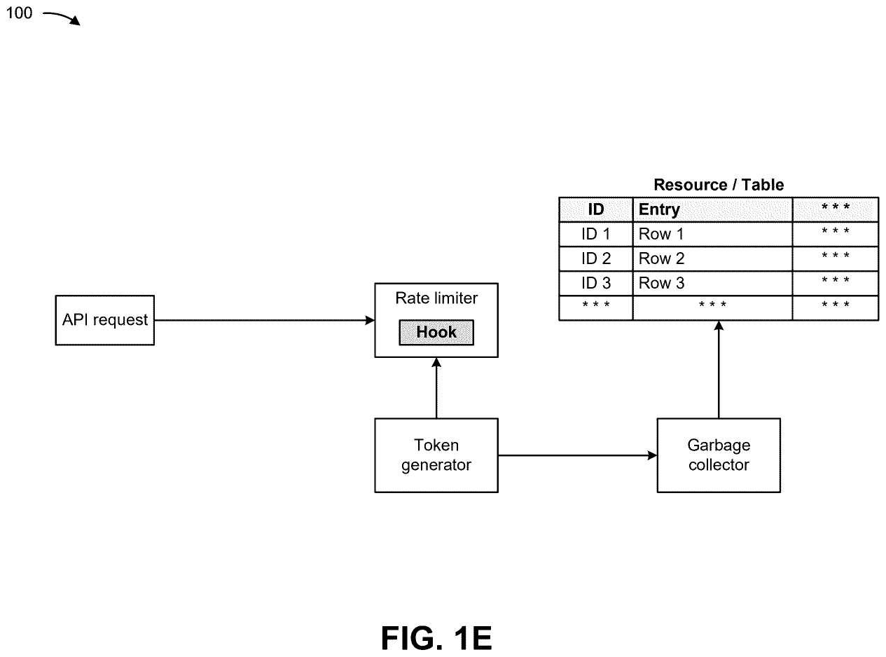

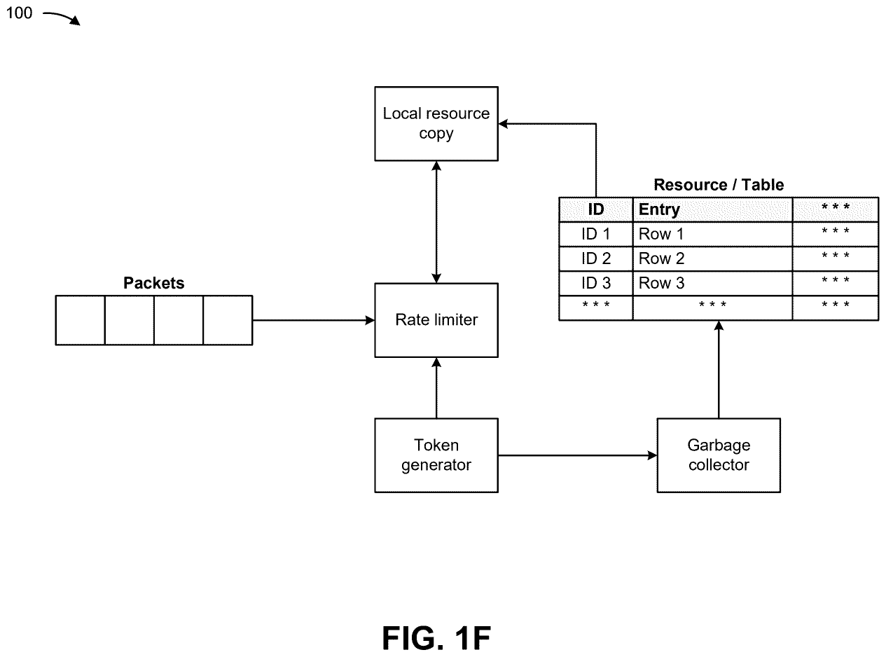

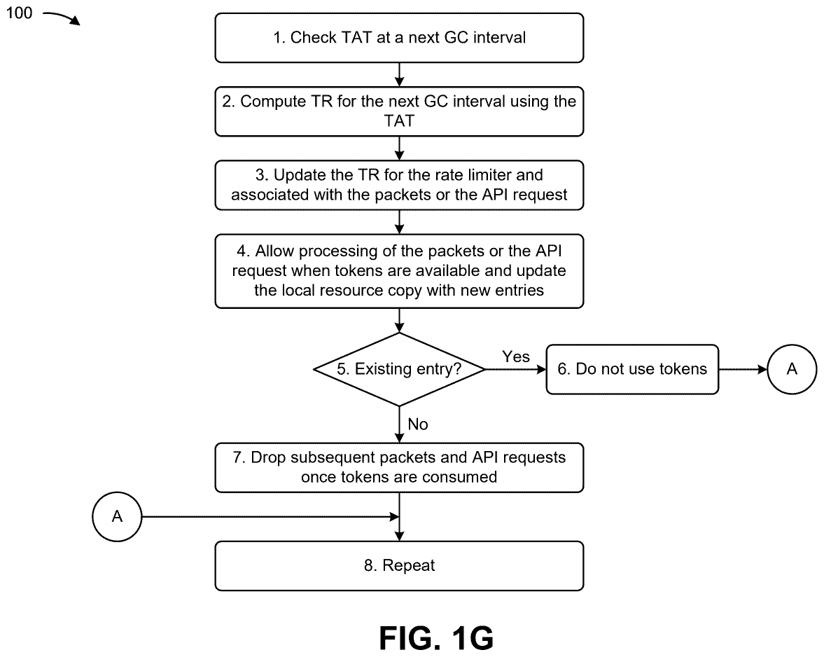

FIGS. 1A-1G are diagrams of an example 100 associated with providing protection for garbage collection supported resources of a device. As shown in FIGS. 1A-1G, the example 100 includes an endpoint device associated with a network and a server device. The network may include multiple network devices, and each of the network devices may include one or more rate limiters or policers. Further details of the endpoint device, the server device, the network, the network devices, and the rate limiters are provided elsewhere herein. Although implementations are described herein in connection with a network device, in some implementations the functions of the network device may be performed by another device, such as the server device.

As shown in FIG. 1A, the network device may include a rate limiter, a garbage collector, and a local resource copy. The rate limiter may provide a control mechanism that regulates a rate at which packets or requests are processed. The rate limiter may ensure that the network device is not overwhelmed by too many requests at once and may maintain the stability and performance of the network. The rate limiter may control a rate at which packets are processed by the network device, thereby preventing network congestion and ensuring fair usage of network resources. By limiting the rate of incoming traffic, the rate limiter may act as a line of defense against distributed denial of service (DDoS) attacks, which flood a network with traffic to disrupt service. The rate limiter may be implemented using several models, such as a token bucket model, a leaky bucket model, a sliding window model, and/or the like. For example, a model may periodically generate tokens based on a configured rate limit, and may store tokens used to process packets. The model may compute a rate at which tokens are generated and consumed, and may adjust a processing rate accordingly. The rate limiter may work in conjunction with the garbage collector and a resource manager to prevent resource exhaustion and promote fair distribution of resources.

The garbage collector may include a software component or subsystem responsible for managing memory and other resources dynamically allocated by the network device. The garbage collector may reclaim memory occupied by objects or resources that are no longer in use by the network device, thereby preventing memory leaks and ensuring efficient use of available resources. The local resource copy may include a local copy of information associated with a resource (e.g., a table) of the network device. For example, the local resource copy may include resource keys for existing entries associated with the resource (e.g., in the table).

As further shown in FIG. 1A, and by reference number 105, the network device may receive packets or an application programming interface (API) request associated with resources (e.g., kernel resources, such as tables) of the network device. For example, a source (e.g., the endpoint device or the server device) may generate packets or an API request associated with a flow of traffic from the source to a destination (e.g., the server device or the endpoint device). In some implementations, the endpoint device may be the source of the packets and the API request, and the server device may be the destination of the packets and the API request. The endpoint device may provide the packets and the API request to the network, and the network device may receive the packets and the API request from the endpoint device. Alternatively, the server device may be the source of the packets and the API request, and the server device may be the destination of the packets and the API request. The server device may provide the packets and the API request to the network, and the network device may receive the packets and the API request from the server device. In some implementations, the flow of traffic may be associated with a DDoS or a denial-of-service (DoS) attack, may be associated with another attack, may be legitimate traffic, and/or the like.

As further shown in FIG. 1A, and by reference number 110, the network device may apply, to the API request, an API hook that limits a request rate and protects the resources. For example, an API hook is a mechanism the intercepts, modifies, extends, or influences behavior of API requests. An API hook may customize a way in which certain functions or methods execute within API requests, without directly modifying the API requests. In some examples, an API hook may intercept API requests before they are fully processed, may append additional information to an API request or filter out sensitive data from an API response, and/or the like.

In some implementations, the network device may generate an API hook that limits a request rate of the rate limiter and protects resources (e.g., kernel resources, such as tables) of the network device. The network device may then apply the API hook to the API request. In some implementations, the API hook may include an extended Berkeley packet filter (eBPF) hook to be applied to the API request. The API hook may be invoked only when a resource is created. For example, the API hook may be invoked when an entry is created and added to a resource table, such as a neighbor table or a connection tracking table. This may enable tokens generated by the rate limiter to be consumed only for packets and API requests that utilize a resource, and not for packets and API requests that perform a lookup or refresh an existing resource entry.

As further shown in FIG. 1A, and by reference number 115, the network device may perform one or more actions based on the API hook. For example, the API hook, when executed, may cause the network device to perform one or more subsequent actions. In some implementations, the API hook may cause the network device to perform additional actions, such as recording events associated with the network device, generating an alarm, performing a resource cleanup, selectively rejecting particular API requests (e.g., rejecting API requests that fail to match particular criteria), and/or the like.

As shown in FIG. 1B, and by reference number 120, the network device may rate limit the packets based on referring to the local resource copy. For example, if the rate limiter of the network device does not have access to the resources and usage of the resources, the rate limiter may rate limit the packets based on referring to the local resource copy. If the local resource copy includes information identifying any of the resources, the rate limiter may not consume tokens for the packets when the packets are associated with any of the resources. In some implementations, the local resource copy may include resource keys associated with existing entries.

As further shown in FIG. 1B, and by reference number 125, the network device may consume a token for one of the packets not associated with an entry in the local resource copy. For example, when an entry is not identified in the local resource copy, the rate limiter of the network device may consume a token and may update the local resource copy with the new entry. In some implementations, when the garbage collector is utilized by the network device for a resource, the garbage collector of the network device may update the local resource copy (e.g., via a copy override) with current content of the resource.

As shown in FIG. 1C, and by reference number 130, the network device may determine a total quantity of available tokens (TAT) at a next garbage collector (GC) interval. For example, for resources that include garbage collection by the garbage collector, in order to purge stale entries at fixed intervals, the network device may utilize a garbage collector interval (e.g., wherever applicable for a resource) as a driving parameter for computation of a total quantity of available tokens and a token allocation rate (or token rate) for the rate limiter. In this way, the network device may protect the resource, may prevent resource exhaustion, and may provide fair resource distribution over time. In some implementations, the network device may utilize a dynamic token allocation rate instead of a static token allocation rate (e.g., one token per second) typically configured for the rate limiter. The network device may calculate the dynamic token rate based on the available resources at a time of the calculation. The calculation of the dynamic token rate may easily be performed when the garbage collector performs periodic garbage collection for resources needing DoS protection (e.g., kernel resource tables).

For example, the garbage collector may clean the kernel resource tables only at the next garbage collector interval, and may not clean current or existing entries in use by the kernel resource tables until the next garbage collector interval. The rate limiter may utilize the next garbage collector interval when generating tokens and calculating the token rates for the next garbage collector interval. Until the next garbage collector interval, the network device may prevent adding new entries to a kernel resource table beyond a capacity of the kernel resource table. The network device may calculate a difference between the capacity of the kernel resource table (e.g., a maximum resource usage) and a current resource usage until the next garbage collector interval, and may purge some of existing entries of the kernel resource table based on the difference. For example, if t is a start time and the garbage collector (GC) interval is n*GC (e.g., for an instance n=1, 2, 3, . . . ), the network device may calculate the difference for each time interval (e.g., t+n*GC). The difference may correspond to a total quantity of available tokens (TAT) at a current garbage collector interval and for the rate limiter.

As further shown in FIG. 1C, and by reference number 135, the network device may calculate a token rate (TR) for the next garbage collector interval based on the total quantity of available tokens. For example, the network device may utilize the total quantity of available tokens of the rate limiter to calculate the token rate of the rate limiter for the next garbage collector interval. In some implementations, the network device may calculate the token rate for the next garbage collector interval by dividing the total quantity of available tokens by the next garbage collector interval (e.g., TR=TAT/GC interval).

As shown in FIG. 1D, and by reference number 140, the network device may update the rate limiter with the token rate. For example, for the next garbage collector interval, the network device may cause the rate limiter to utilize the token rate when generating tokens. In some implementations, the network device may continuously update the token rate of the rate limiter as the token rate is modified for subsequent garbage collector intervals. In some implementations, the network device may update the token rate of the rate limiter more frequently than the garbage collector interval, to provide a token rate that follows current usage more closely. For example, if tokens remain from a past garbage collector interval, the network device may reallocate the remaining tokens across remaining intervals before the next garbage collector interval. In one example, if a next garbage collector interval is 120 seconds, then the network device may perform the token rate computation every 40 seconds (e.g., a 0 seconds, 40 seconds, and 80 seconds) and may compute the tokens three times for every garbage collector interval. Thus, the calculation may change to: token rate (TR)=TAT/time to next GC interval (e.g., TAT at 0 seconds, 40 seconds, and 80 seconds/120 seconds, 80 seconds, and 40 seconds, respectively, for the three windows).

If there are multiple garbage collector intervals set up for a kernel resource table, the network device may utilize a smallest interval in these computations. Releasing only the total quantity of available resources worth of tokens for the rate limiter for a garbage collector interval as the token rate may ensure that the network device drops bursty traffic and allows token usage only up to a maximum capacity of a kernel resource table. Thus, if some tokens are unused for an interval if an initial time period is bursty (e.g., when the computations are calculated), the network device may overrun the kernel resource table. Any forced garbage collection, preemptively cleaning up a resource, may be identified by an additional eBPF hook that updates the total quantity of available resources or the token rate, or may be adjusted subsequently during the next garbage collector interval calculations when the total quantity of available resources is re-checked.

As further shown in FIG. 1D, and by reference number 145, the network device may allow processing of one of the packets or the API request when a token is available from the rate limiter and may update the local resource copy. For example, the network device may determine whether a token is available from the rate limiter. When a token is available from the rate limiter, the network device may utilize the token to allow processing of one of the packets or the API request. Alternatively, when a token is not available from the rate limiter, the network device may prevent processing of the packets and the API request.

As further shown in FIG. 1D, and by reference number 150, the network device may drop subsequent packets and API requests once tokens are consumed. For example, the network device may determine when all of the tokens of the rate limiter are consumed. When all of the tokens of the rate limiter are consumed, the network device may drop (e.g., prevent processing of) subsequent packets and/or API requests received by the network device.

FIG. 1E depicts example functions capable of being performed by the network device. As shown, the rate limiter of the network device may receive an API request, and may apply, to the API request, an API hook that limits a request rate of the rate limiter and protects the resource (e.g., the kernel resource table that includes identifiers (IDs) and entries). The token generator may generate tokens based on the request rate enabled by the API hook, and may provide the tokens to the rate limiter and the garbage collector. The rate limiter may utilize one of the tokens to process the API request and cause the resource to be utilized (e.g., provide an entry in the table, remove an entry from the table, and/or the like). The garbage collector may reclaim memory occupied by the resources that are no longer in use by the network device (e.g., entries in the table).

FIG. 1F depicts example functions capable of being performed by the network device. As shown, the rate limiter of the network device may receive packets. If the rate limiter of the network device does not have access to the resources and usage of the resources (e.g., the kernel resource table that includes IDs and entries), the rate limiter may rate limit the packets based on referring to the local resource copy. If the local resource copy includes information identifying the resource, the rate limiter may not consume tokens (e.g., generated by the token generator) for the packets when the packets are associated with the resource. The token generator may generate tokens for the packets not associated with entries in the local resource copy. For example, when an entry is not identified in the local resource copy, the rate limiter of the network device may consume a token and may update the local resource copy with the new entry. In some implementations, when the garbage collector is utilized by the network device for the resource, the garbage collector may update the local resource copy (e.g., via a copy override) with current content of the resource.

FIG. 1G depicts an example of a process flow capable of being performed by the network device. As shown at step 1, the network device may check the total quantity of available resources (TAT) at a next garbage collector (GC) interval. As shown at step 2, the network device may compute the token rate (TR) for the next garbage collector interval using the total quantity of available resources. As shown at step 3, the network device may update the token rate for the rate limiter and associated with the packets or the API request. As shown at step 4, the network device may allow processing of the packets or the API request when tokens are available and may update the local resource copy with new entries. As shown at step 5, the network device may determine whether there is an existing entry in the local resource copy associated with the packets or the API request. When there is an existing entry in the local resource copy associated with the packets or the API request (step 5—Yes), the network device may not use tokens to process the packets or the API request (step 6) and may repeat the process flow from step 1 (step 8). When there is no existing entry in the local resource copy associated with the packets or the API request (step 5—No), the network device may drop subsequent packets and API requests once the tokens are consumed (step 7) and may repeat the process flow from step 1 (step 8).

In this way, the network device provides protection for garbage collection supported resources of the network device. For example, the network device may apply an eBPF hook to an API request, where the eBPF hook rate limits a request rate of a rate limiter and protects the kernel resources. The eBPF hook may be applied to the API requests that are invoked only when a resource is created. Alternatively, or additionally, the network device may rate limit packets by referring to a local resource copy associated with resources of the network device. Alternatively, or additionally, for resources associated with a garbage collector, the network device may utilize a garbage collector interval as a parameter for calculating a total quantity of currently available tokens and a token rate for the rate limiter. This may protect the resources of the network device by preventing resource exhaustion and promoting fair resource distribution over time. Thus, the network device conserves computing resources, networking resources, and/or the like that would otherwise have been consumed by failing to provide optimal use of resource tables, failing to prevent resource table overflows, dropping legitimate packets due to generating tokens for illegitimate packets, handling customer complaints associated with resource table overflows and dropping legitimate packets, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

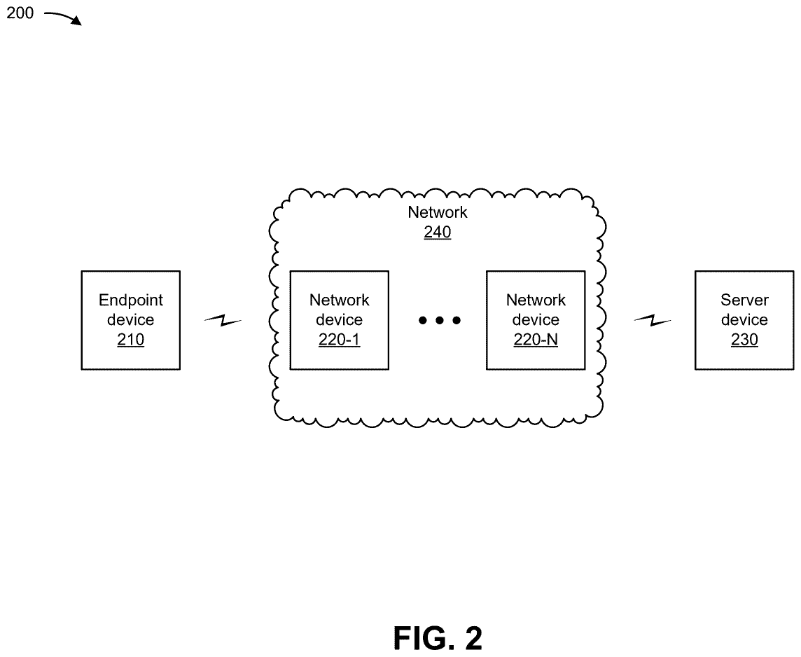

FIG. 2 is a diagram of an example environment 200 in which systems and/or methods described herein may be implemented. As shown in FIG. 2, environment 200 may include an endpoint device 210, a group of network devices 220 (shown as network device 220-1 through network device 220-N), a server device 230, and a network 240. Devices of the environment 200 may interconnect via wired connections, wireless connections, or a combination of wired and wireless connections.

The endpoint device 210 includes one or more devices capable of receiving, generating, storing, processing, and/or providing information, such as information described herein. For example, the endpoint device 210 may include a mobile phone (e.g., a smart phone or a radiotelephone), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, or a head mounted display), a network device, a server device, a group of server devices, or a similar type of device. In some implementations, the endpoint device 210 may receive network traffic from and/or may provide network traffic to other endpoint devices 210 and/or the server device 230, via the network 240 (e.g., by routing packets using the network devices 220 as intermediaries).

The network device 220 includes one or more devices capable of receiving, processing, storing, routing, and/or providing traffic (e.g., a packet or other information or metadata) in a manner described herein. For example, the network device 220 may include a router, such as a label switching router (LSR), a label edge router (LER), an ingress router, an egress router, a provider router (e.g., a provider edge router or a provider core router), a virtual router, a route reflector, an area border router, or another type of router. Additionally, or alternatively, the network device 220 may include a gateway, a switch, a firewall, a hub, a bridge, a reverse proxy, a server (e.g., a proxy server, a cloud server, or a data center server), a load balancer, and/or a similar device. In some implementations, the network device 220 may be a physical device implemented within a housing, such as a chassis. In some implementations, the network device 220 may be a virtual device implemented by one or more computer devices of a cloud computing environment or a data center. In some implementations, a group of network devices 220 may be a group of data center nodes that are used to route traffic flow through the network 240.

The server device 230 may include one or more devices capable of receiving, generating, storing, processing, providing, and/or routing information, as described elsewhere herein. The server device 230 may include a communication device and/or a computing device. For example, the server device 230 may include a server, such as an application server, a client server, a web server, a database server, a host server, a proxy server, a virtual server (e.g., executing on computing hardware), or a server in a cloud computing system. In some implementations, the server device 230 may include computing hardware used in a cloud computing environment.

The network 240 includes one or more wired and/or wireless networks. For example, the network 240 may include a packet switched network, a cellular network (e.g., a fifth generation (5G) network, a fourth generation (4G) network, such as a long-term evolution (LTE) network, a third generation (3G) network, and/or a code division multiple access (CDMA) network), a public land mobile network (PLMN), a local area network (LAN), a WAN, a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

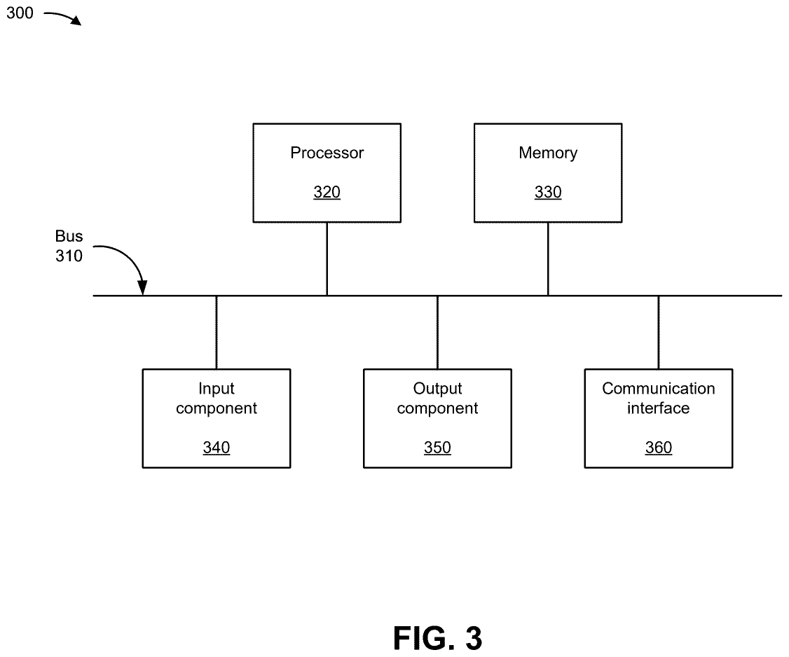

FIG. 3 is a diagram of example components of one or more devices of FIG. 2. The example components may be included in a device 300, which may correspond to the endpoint device 210, the network device 220, and/or the server device 230. In some implementations, the endpoint device 210, the network device 220, and/or the server device 230 may include one or more devices 300 and/or one or more components of the device 300. As shown in FIG. 3, the device 300 may include a bus 310, a processor 320, a memory 330, an input component 340, an output component 350, and a communication interface 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an accelerated processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication interface 360 enables the device 300 to communicate with other devices via a wired connection and/or a wireless connection. For example, the communication interface 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

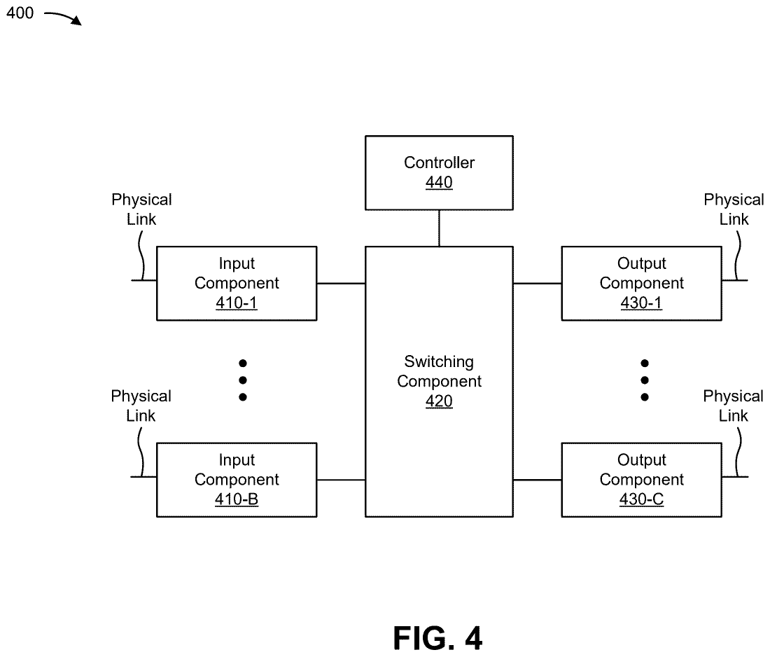

FIG. 4 is a diagram of example components of one or more devices of FIG. 2. The example components may be included in a device 400. The device 400 may correspond to the network device 220. In some implementations, the network device 220 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication interface. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

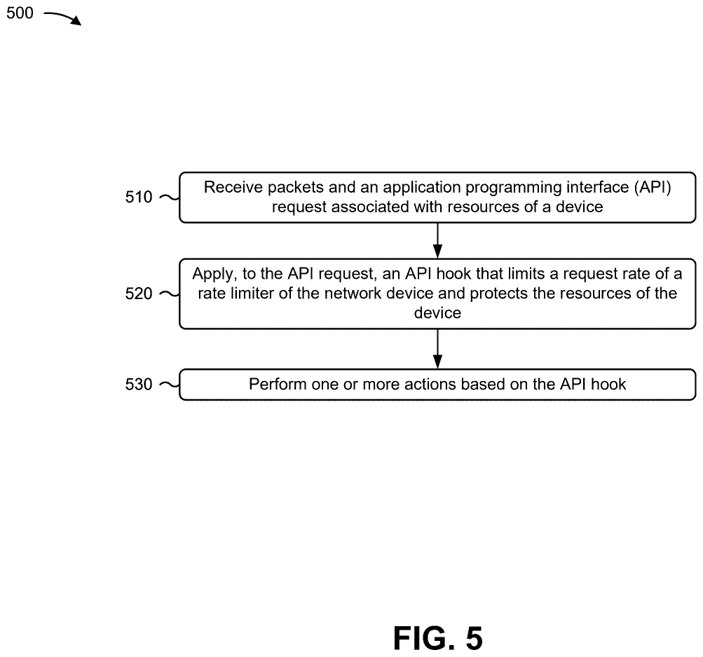

FIG. 5 is a flowchart of an example process 500 for providing protection for garbage collection supported resources of a device. In some implementations, one or more process blocks of FIG. 5 may be performed by a device (e.g., a first network device 220). In some implementations, one or more process blocks of FIG. 5 may be performed by another device or a group of devices separate from or including the device, such as an endpoint device (e.g., the endpoint device 210), a server device (e.g., the server device 230), and/or another network device (e.g., the network device 220). Additionally, or alternatively, one or more process blocks of FIG. 5 may be performed by one or more components of the device 300, such as the processor 320, the memory 330, the input component 340, the output component 350, and/or the communication interface 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include receiving packets or an API request associated with resources of the device (block 510). For example, the device may receive packets or an API request associated with resources of the device, as described above. In some implementations, the resources are kernel resources of the device.

As further shown in FIG. 5, process 500 may include applying, to the API request, an API hook that limits a request rate of a rate limiter of the device and protects the resources of the device (block 520). For example, the device may apply, to the API request, an API hook that limits a request rate of a rate limiter of the device and protects the resources of the device, as described above. In some implementations, the API hook is an extended Berkeley packet filter API hook.

As further shown in FIG. 5, process 500 may include performing one or more actions based on the API hook (block 530). For example, the device may perform one or more actions based on the API hook, as described above. In some implementations, performing the one or more actions based on the API hook includes one or more of recording an event associated with the device, generating an alarm, performing a resource cleanup, or selectively rejecting particular API requests.

In some implementations, process 500 includes rating limiting the packets based on referring to a local resource copy of the device. In some implementations, process 500 includes consuming a token for one of the packets not associated with an entry in the local resource copy. In some implementations, the local resource copy includes resource keys associated with the resources of the device.

In some implementations, process 500 includes determining a total quantity of available tokens of the rate limiter at a next interval associated with a garbage collector of the device, calculating a token rate for the next interval based on the total quantity of available tokens, and updating the rate limiter with the token rate. In some implementations, calculating the token rate for the next interval based on the total quantity of available tokens comprises dividing the total quantity of available tokens by the next interval to calculate the token rate. In some implementations, the rate limiter utilizes the token rate to create tokens for the next interval.

In some implementations, process 500 includes allowing processing of one of the packets or the API request when a token is available from the rate limiter, and updating a local resource copy of the device based on allowing processing of one of the packets or the API request. In some implementations, process 500 includes dropping subsequent packets and API requests based on tokens of the rate limiter being consumed. In some implementations, process 500 includes calculating, based on the total quantity of available tokens, another token rate for an interval that is less than the next interval, and updating the rate limiter with the other token rate.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, packets or an application programming interface (API) request associated with resources of the device;
applying, by the device and to the API request, an API hook that limits a request rate of a rate limiter of the device and protects the resources of the device; and
performing, by the device, one or more actions based on the API hook.

2. The method of claim 1, further comprising:
rate limiting the packets based on referring to a local resource copy of the device.

3. The method of claim 2, further comprising:
consuming a token for one of the packets not associated with an entry in the local resource copy.

4. The method of claim 2, wherein the local resource copy includes resource keys associated with the resources of the device.

5. The method of claim 1, wherein the resources are kernel resources of the device.

6. The method of claim 1, wherein the API hook is an extended Berkeley packet filter API hook.

7. The method of claim 1, wherein performing the one or more actions based on the API hook comprises one or more of:
recording an event associated with the device;
generating an alarm;
performing a resource cleanup; or
selectively rejecting particular API requests.

8. A device, comprising:
one or more memories; and
one or more processors to:
receive packets or an application programming interface (API) request associated with resources of the device,
wherein the resources are kernel resources of the device;
apply, to the API request, an API hook that limits a request rate of a rate limiter of the device and protects the resources of the device; and
perform one or more actions based on the API hook.

9. The device of claim 8, wherein the one or more processors are further to:
determine a total quantity of available tokens of the rate limiter at a next interval associated with a garbage collector of the device;
calculate a token rate for the next interval based on the total quantity of available tokens; and
update the rate limiter with the token rate.

10. The device of claim 9, wherein the one or more processors are further to:
allow processing of one of the packets or the API request when a token is available from the rate limiter; and
update a local resource copy of the device based on allowing processing of one of the packets or the API request.

11. The device of claim 9, wherein the one or more processors are further to:
drop subsequent packets and API requests based on tokens of the rate limiter being consumed.

12. The device of claim 9, wherein the one or more processors, to calculate the token rate for the next interval based on the total quantity of available tokens, are to:
divide the total quantity of available tokens by the next interval to calculate the token rate.

13. The device of claim 9, wherein the rate limiter utilizes the token rate to create tokens for the next interval.

14. The device of claim 9, wherein the one or more processors are further to:
calculate, based on the total quantity of available tokens, another token rate for an interval that is less than the next interval; and
update the rate limiter with the other token rate.

15. A non-transitory computer-readable medium storing a set of instructions, the set of instructions comprising:
one or more instructions that, when executed by one or more processors of a device, cause the device to:
receive packets or an application programming interface (API) request associated with resources of the device,
wherein the resources are tables of the device;
apply, to the API request, an API hook that limits a request rate of a rate limiter of the device and protects the resources of the device; and
perform one or more actions based on the API hook.

16. The non-transitory computer-readable medium of claim 15, wherein the one or more instructions further cause the device to:
rate limit the packets based on referring to a local resource copy of the device; and
consume a token for one of the packets not associated with an entry in the local resource copy.

17. The non-transitory computer-readable medium of claim 15, wherein the one or more instructions, that cause the device to perform the one or more actions based on the API hook, cause the device to one or more of:
record an event associated with the device;
generate an alarm;
perform a resource cleanup; or
selectively reject particular API requests.

18. The non-transitory computer-readable medium of claim 15, wherein the one or more instructions further cause the device to:
determine a total quantity of available tokens of the rate limiter at a next interval associated with a garbage collector of the device;
calculate a token rate for the next interval based on the total quantity of available tokens; and
update the rate limiter with the token rate.

19. The non-transitory computer-readable medium of claim 18, wherein the one or more instructions further cause the device to:
allow processing of one of the packets or the API request when a token is available from the rate limiter; and
update a local resource copy of the device based on allowing processing of one of the packets or the API request.

20. The non-transitory computer-readable medium of claim 18, wherein the one or more instructions further cause the device to:
drop subsequent packets and API requests based on tokens of the rate limiter being consumed.
